(19) United States
(12) Patent Application Publication
(10) Pub. No.: US 2022/0404130 A1
(43) Pub. Date: Dec. 22, 2022

(54) CONTROL UNIT FOR INTERFACING WITH A BLASTING PLAN LOGGER

(71) Applicant: PYYLAHTI OY, Helsinki (FI)

(72) Inventor: Tapio LAAKKO, Helsinki (FI)

(21) Appl. No.: 17/642,922

(22) PCT Filed: Sep. 16, 2020
(86) PCT No.: PCT/FI2020/050594

§ 371 Date: Mar. 14, 2022

(30) Foreign Application Priority Data
Sep. 16, 2019 (FI) 20195771
Sep. 17, 2019 (FI) 20195775

(51) Int. Cl. F42D 1/05; G06F 3/01; G10L 15/22

(52) U.S. Cl. CPC F42D 1/05; G06F 3/014; G10L 15/22; G10L 2015/223; G06V 40/18

(57) ABSTRACT

The invention allows improved planning and implementation of blasting operations. A control unit for interfacing with a blasting plan logger is connected via a first interface to at least a headset comprising a wearable display. The control unit comprises at least one processor, and at least one memory comprising computer program code. The at least one memory and the computer program code are configured to, with the at least one processor, cause the control unit to at least operate the wearable display via the first interface to display information from a blasting plan logger to a user on the wearable display.

### BACKGROUND OF THE INVENTION

### Field of the Invention

The present application generally relates to blasting operations. In particular, the present application relates to a control unit for interfacing with a blasting plan logger.

### Description of the Related Art

Planning and implementing a blasting operation currently requires typically at least four separate devices: a purpose-built Global Positioning System (GPS) device, a computer, a purpose-built logger device and an initiating device.

The purpose-built GPS-device is used to obtain GPS locations of the bore holes. Alternatively, GPS locations of the bore holes are not obtained at all. Such purpose-built GPS-devices are typically accurate but expensive. The computer has design software usually provided by detonator manufacturer(s). Typically, a blasting plan can only be created with this software. A completed blasting plan is transferred from the computer to the purpose-built logger device via a Bluetooth or cable connection. The purpose-built logger device is then used to scan barcodes or Quick Response (QR) codes of the detonators that will be used at the blasting field. This information is sent to the initiating device which is used to blast the field. Finally, the initiat ing device will be connected to a primary wire of the field, and the field will be blasted with the initiating device.

Typically, the current devices needed to access the blasting plan and program the detonators are handheld devices in the sense that at least one hand (and typically both hands) is required to hold and operate these devices. In other words, the user's (i.e. the blasting person setting the detonators and explosives for the bore holes at the field) hands are not free for other tasks.

Furthermore, the user's field of vision needs to be fixed on these devices (e.g. looking down and focusing on the display of the logger device that the user is keeping in his/her hands).

The above leads to diminished efficiency and safety during work. This is a particularly significant disadvantage when the work includes dangerous tasks, such as working with detonators and explosives.

### SUMMARY OF THE INVENTION

An embodiment of a control unit for interfacing with a blasting plan logger is connected via a first interface to at least a headset comprising a wearable display. The control unit comprises at least one processor, and at least one memory comprising computer program code. The at least one memory and the computer program code are configured to, with the at least one processor, cause the control unit to at least:

operate the wearable display via the first interface to display information from a blasting plan logger to a user on the wearable display.

In an embodiment, alternatively or in addition to the above described embodiments, the headset further comprises a microphone. The at least one memory and the computer program code are further configured to, with the at least one processor, cause the control unit to:

operate the microphone via the first interface to receive a voice command from the user of the control unit for at least one of operating the control unit or interacting with the blasting plan logger; and

execute the received voice command.

In an embodiment, alternatively or in addition to the above described embodiments, the at least one memory and the computer program code are further configured to, with the at least one processor, cause the control unit to:

operate the microphone via the first interface to receive a voice sample from the user; and

perform voice recognition on the received voice sample.

In an embodiment, alternatively or in addition to the above described embodiments, the headset further comprises a digital camera. The at least one memory and the computer program code are further configured to, with the at least one processor, cause the control unit to:

operate the digital camera via the first interface to read a visual identifier of an electronic detonator.

In an embodiment, alternatively or in addition to the above described embodiments, the at least one memory and the computer program code are further configured to, with the at least one processor, cause the control unit to:

operate the digital camera via the first interface to record a video log about activities of the user.

In an embodiment, alternatively or in addition to the above described embodiments, the at least one memory and the computer program code are further configured to, with the at least one processor, cause the control unit to:

operate the digital camera via the first interface to receive a video feed at least partially covering an eye of the user; and

perform biometric user identification based on the received video feed.

In an embodiment, alternatively or in addition to the above described embodiments, the control unit is further connected to a high-accuracy positioning unit. The at least one memory and the computer program code are further configured to, with the at least one processor, cause the control unit to:

determine the location of the user based on signaling received by the high-accuracy positioning unit.

In an embodiment, alternatively or in addition to the above described embodiments, the at least one memory and the computer program code are further configured to, with the at least one processor, cause the control unit to:

determine the location of the user based on one or more received voice commands.

In an embodiment, alternatively or in addition to the above described embodiments, the at least one memory and the computer program code are further configured to, with the at least one processor, cause the control unit to:

operate the wearable display via the first interface to provide visual feedback to the user.

In an embodiment, alternatively or in addition to the above described embodiments, the headset further comprises a speaker. The at least one memory and the computer program code are further configured to, with the at least one processor, cause the control unit to:

operate the speaker via the first interface to provide audio feedback to the user.

In an embodiment, alternatively or in addition to the above described embodiments, the control unit is further connected via a second interface to a handset comprising a wearable near-field communication tag reader. The at least one memory and the computer program code are further configured to, with the at least one processor, cause the control unit to:

operate the wearable near-field communication tag reader via the second interface to read an identifier of an electronic detonator comprised in a near-field communication tag associated with the electronic detonator.

In an embodiment, alternatively or in addition to the above described embodiments, the control unit further comprises a long-range wireless transceiver for communicating with an external communication network.

In an embodiment, alternatively or in addition to the above described embodiments, the wearable display is comprised in a safety helmet visor.

In an embodiment, alternatively or in addition to the above described embodiments, the wearable display is comprised in smart glasses.

In an embodiment, alternatively or in addition to the above described embodiments, the wearable near-field communication tag reader is comprised in a glove.

In an embodiment, alternatively or in addition to the above described embodiments, the wearable near-field communication tag reader is wrist attachable.

In an embodiment, alternatively or in addition to the above described embodiments, the control unit is comprised in a smart phone.

In an embodiment, alternatively or in addition to the above described embodiments, the control unit is comprised in a smart watch.

At least some of the embodiments allow inter-facing with a blasting plan logger using a control unit connected to at least a headset comprising a wearable display. Accordingly, hands of the user become free for working. Furthermore, at least some of the embodiments allow the user's field of vision to be fixed on the actual work operation, rather than e.g. looking down and focusing on the display of the logger device at the hands/lap of the user or on the ground. This allows enhanced efficiency and safety during work. This is a particularly significant advantage when the work includes dangerous tasks, such as working with detonators and explosives.

At least some of the embodiments allow interfacing with a blasting plan logger using voice control. Again, this allows enhanced efficiency and safety during work since hands of the user become free for working and the user's field of vision can be fixed on the actual work operation.

At least some of the embodiments allow recording a video log about the activities or work flow of the user (i.e. the blasting person setting the detonators and explosives for the bore holes at the field), thereby facilitating fulfilling legal requirements, making it possible to determine what happened if something goes wrong (and finding out the responsible party for a mistake). A video log is also useful for training purposes.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates an overview of an example system, where various embodiments of the present disclosure may be implemented;

FIG. 2A illustrates an example block diagram of a wearable system for interfacing with a blasting plan logger in accordance with an example embodiment;

FIG. 2B illustrates an example block diagram of a headset in accordance with an example embodiment;

FIG. 2C illustrates an example block diagram of a control unit in accordance with an example embodiment; and

FIG. 2D illustrates an example block diagram of a handset in accordance with an example embodiment.

Like reference numerals are used to designate like parts in the accompanying drawings.

### DETAILED DESCRIPTION OF THE INVENTION

Reference will now be made in detail to embodiments of the present invention, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

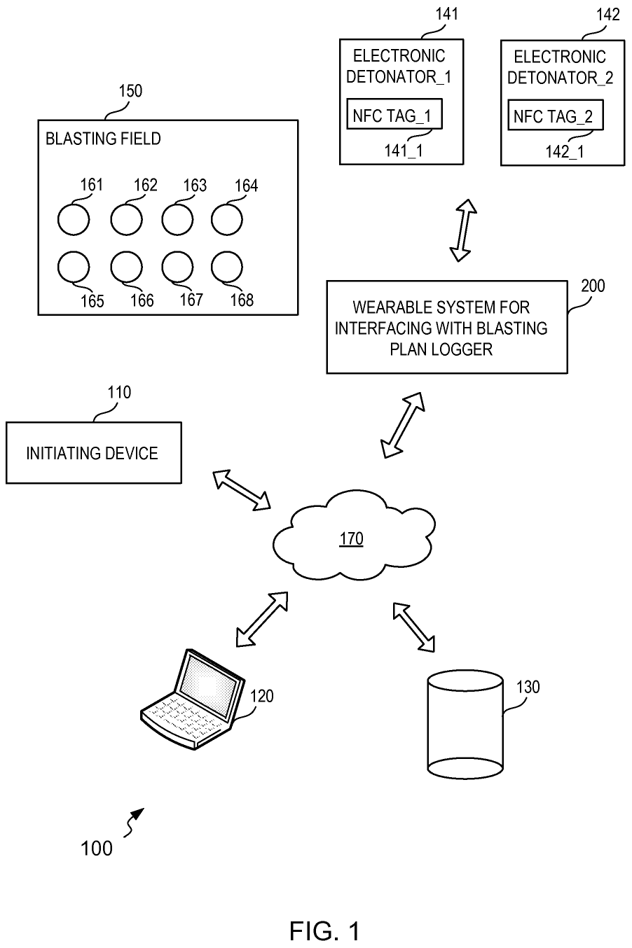

FIG. 1 illustrates an overview of an example system 100 in which various embodiments of the present disclosure may be implemented. An example representation of the system 100 is shown depicting a network 170 that connects entities such as a wearable system 200, an initiating device 110, an optional computing device 120, and a remote database 130. The network 170 may be a centralized network or may comprise a plurality of sub-networks that may offer a direct communication between the entities or may offer indirect communication between the entities. Examples of the network 170 include wireless networks, wired networks, and combinations thereof. Some non-exhaustive examples of wireless networks may include wireless local area networks (WLANs), Bluetooth or Zigbee networks, cellular networks and the like. Some non-exhaustive examples of wired networks may include Local Area Networks (LANs), Ethernet, Fiber Optic networks and the like. An example of a combination of wired networks and wireless networks may include the Internet.

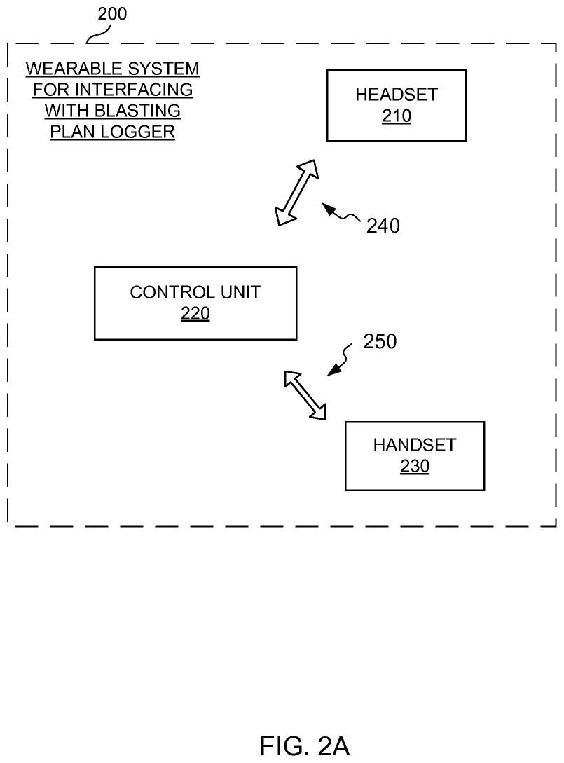

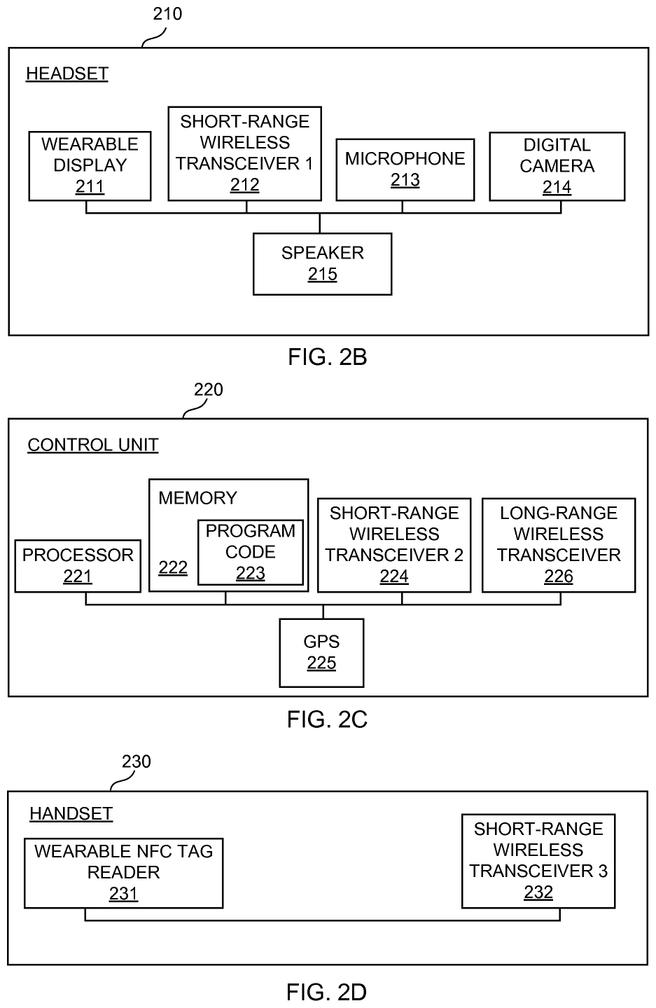

The wearable system 200 may include e.g. the wearable system 200 of FIG. 2A. The optional computing device 120 may include e.g. a smart phone, tablet computer, laptop computer, a two-in-one hybrid computer, a desktop computer, a network terminal, or the like. As described in more detail below, software deployed in a control unit 220 of the wearable system 200 may be used or may function as a blasting plan logger. Herein, the “blasting plan logger” refers to software and/or hardware for facilitating planning and/or implementing blasting operations.

The control unit 220, the initiating device 110 and/or the optional computing device 120 may utilize the remote database 130. For example, bore hole maps, topographic maps and/or blasting plans utilized in the various embodiments described herein may be stored in the database 130 in addition to storing their local copies in the control unit 220, the initiating device 110 and/or the optional computing device 120.

The system 100 further includes electronic detonators 141, 142. As is known in the art, electronic (or digital) detonators are designed to provide precise control necessary to produce accurate and consistent blasting results in a variety of blasting applications e.g. in mining, quarrying, and construction industries. Typically, delays for electronic detonators may be programmed in one-millisecond increments from 1 millisecond to 16000 milliseconds. The delay assigned for an electronic detonator is programmed to a chip comprised in the electronic detonator. An electronic detonator further comprises a detonator wire which is used to connect the electronic detonator to a primary wire of the blasting field. The primary wire in turn is connected to the initiating device 110. Each electronic detonator also has an associated identification code which may be unique to the electronic detonator. The identification code may be comprised in an identifier 141_1, 142_1 of the respective electronic detonator 141, 142. In at least some of the embodiments, the identifier 141_1, 142_1 may comprise a NFC tag. Alternatively, the identifier 141_1, 142_1 may comprise a visual identifier, such as a barcode, a QR (quick response) code, or numerical code.

FIG. 1 also shows a blasting field 150 with one or more bore holes 161-168 configured to receive explosives and one or more electronic detonators 141, 142. The blasting field 150 may be located e.g. in a mine, a quarry, a construction site, or the like. Typically, there are several bore holes in a blasting field. For example, a blasting field in a quarry may have two hundred or more bore holes. Often, the bore holes are arranged in a grid like pattern. The distance between two bore holes may be e.g. substantially two meters in direction and substantially three meters in another direction. The depth of a bore hole may be e.g. substantially 2-30 meters.

The locations of the bore holes 161-168 are indicated in a bore hole map and transferred to a blasting plan. The bore hole map and the blasting plan may also include other information related to the bore holes 161-168, such as depth and/or diameter and/or inclination of each bore hole. When a given bore hole is assigned to receive two or more detonators, these detonators are typically arranged at different depths in the bore hole. In such a case, the blasting plan may also include information about the assigned depth of each detonator in the bore hole, and/or information about the assigned order in which the detonators are to be placed in the bore hole (the detonator to be placed first in the bore hole will typically be the one closest to the bottom of the bore hole, and the detonator to be placed last in the bore hole will typically be the one closest to the surface of the bore hole).

The locations and dimensions of the bore holes 161-168 together with the associated detonator delays may be used to control the direction of the power of the blast, e.g. away from nearby buildings, electric power lines, roads, and the like. The initiating device 110 is used to initiate the blasting of the field 150.

FIG. 2A is a block diagram of a wearable system 200 in accordance with an example embodiment. The wearable system 200 is configured to facilitate handsfree interfacing with a blasting plan logger.

The wearable system 200 comprises a headset 210 and a control unit 220 for interfacing with a blasting plan logger. The wearable system 200 may further comprise a handset 230.

As shown in FIG. 2B, the headset 210 comprises a wearable display 211. The headset 210 may further comprise a first short-range wireless (such as Bluetooth or the like) transceiver 212, a microphone 213, a digital camera 214, and/or a speaker 215. The wearable display 211 may be comprised e.g. in a safety helmet visor or in smart glasses. The headset 210 may comprise e.g. an augmented reality (AR) headset, a virtual reality (VR) headset, or a mixed reality (MR) headset.

As shown in FIG. 2D, the handset 230 comprises a wearable near-field communication (NFC) tag reader 231. The wearable near-field communication tag reader 231 may be comprised e.g. in a glove (such as a working glove or the like), or the wearable near-field communication tag reader 231 may be e.g. wrist-attachable. The handset 230 may further comprise a third short-range wireless (such as Bluetooth or the like) transceiver 232.

As is known in the art, NFC is a short-range wireless connectivity technology standard designed for simple and safe communication between electronic devices. The technology is an extension of the ISO/IEC 14443 proximity-card standard. In an embodiment, the near field communication comprises radio-frequency identification (RFID). As is commonly known, the term “radio-frequency identification” refers to a technology that uses communication via electromagnetic waves to exchange data be-tween a terminal and an object such as a product, animal, or person for the purpose of identification and tracking, for example.

As shown in FIG. 2C, the control unit 220 for interfacing with a blasting plan logger comprises one or more processors 221, and one or more memories 222 that comprise computer program code 223. The control unit 220 may further comprise a second short-range wireless (such as Bluetooth or the like) transceiver 224, and/or a long-range wireless transceiver 226 for communicating with the external communication network 170. Furthermore, the control unit 220 may be connected to a high-accuracy positioning unit 225. The high-accuracy positioning unit 225 may be integrated with the control unit 220, in which case the control unit 220 may be connected to the high-accuracy positioning unit 225 via a suitable internal interface. Alternatively, the high-accuracy positioning unit 225 may be external to the control unit 220, in which case the control unit 220 may be connected to the high-accuracy positioning unit 225 via a suitable external interface.

Although the control unit 220 is depicted to include only one processor 221, the control unit 220 may include more processors. In an embodiment, the memory 222 is capable of storing instructions, such as an operating system and/or various applications.

Furthermore, the processor 221 is capable of executing the stored instructions. In an embodiment, the processor 221 may be embodied as a multi-core processor, a single core processor, or a combination of one or more multi-core processors and one or more single core processors. For example, the processor 221 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 221 may be configured to execute hard-coded functionality. In an embodiment, the processor 221 is embodied as an executor of software instructions, wherein the instructions may specifically configure the processor 221 to perform the algorithms and/or operations described herein when the instructions are executed.

The memory 222 may be embodied as one or more volatile memory devices, one or more non-volatile memory devices, and/or a combination of one or more volatile memory devices and non-volatile memory devices. For example, the memory 222 may be embodied as semiconductor memories (such as mask ROM, PROM (programmable ROM), EPROM (erasable PROM), flash ROM, RAM (random access memory), etc.), or the like.

In an embodiment, the blasting plan logger may be implemented as software, and stored e.g. in the memory 222 of the control unit 220. In another embodiment, the blasting plan logger may be implemented as a device or software external to the wearable system 200, and the control unit 220 may be configured to communicate with the blasting plan logger e.g. via the long-range wireless transceiver 226.

The high-accuracy positioning unit 225 may comprise a positioning unit capable of positioning accuracy of at least substantially 50 centimeters, and/or capable of utilizing L5 positioning signaling. Examples of positioning systems include global navigation satellite systems (GNSS), such as Global Positioning System (GPS), Global Navigation Satellite System (GLONASS), Galileo, and the like.

The L5 frequency band is used at least by GPS. This frequency falls into a range for aeronautical navigation, with little or no interference under any circumstances. The L5 consists of two carrier components that are in phase quadrature with each other. L5 (also known as “the third civil GPS signal”) is planned to support e.g. safety-of-life applications for aviation and provide improved availability and accuracy.

An example of the high-accuracy positioning unit 225 includes GPS chip BCM47755 from Broadcom, and the like.

The control unit 220 for interfacing with a blasting plan logger is connected at least to the head-set 210 comprising the wearable display 211. The control unit 220 is connected to the headset 210 via a first interface 240, as shown in FIG. 2A. In an embodiment, the control unit 220 and the headset 210 are physically separate devices, and the first interface 240 may comprise e.g. a first short-range wireless connection between the first short-range wireless transceiver 212 and the second short-range wireless transceiver 224.

In another embodiment, the control unit 220 and the headset 210 are integrated in a single device, and the first interface 240 may comprise e.g. an internal interface, such as a suitable centralized circuit or the like. The centralized circuit may be various devices configured to, among other things, provide or enable communication between the control unit 220 and the head-set 210. In certain embodiments, the centralized circuit may be a central printed circuit board (PCB) such as a motherboard, a main board, a hand-held apparatus board, or a logic board. The centralized circuit may also, or alternatively, include other printed circuit assemblies (PCAs) or communication channel media.

In embodiments comprising the handset 230, the control unit 220 for interfacing with a blasting plan logger is connected to the handset 230 via a second interface 250, as shown in FIG. 2A. In an embodiment, the control unit 220 and the handset 230 are physically separate devices, and the second interface 250 may comprise e.g. a second short-range wireless connection between the third short-range wireless transceiver 232 and the second short-range wireless transceiver 224.

In an embodiment, the control unit 220 and the handset 230 are integrated in a single device, and the second interface 250 may comprise e.g. an internal interface, such as a suitable centralized circuit or the like. The centralized circuit may be various devices configured to, among other things, provide or enable communication between the control unit 220 and the hand-set 230. In certain embodiments, the centralized circuit may be a central printed circuit board (PCB) such as a motherboard, a main board, a hand-held apparatus board, or a logic board. The centralized circuit may also, or alternatively, include other printed circuit assemblies (PCAs) or communication channel media.

In embodiments in which the control unit 220 is physically separate from the headset 210 and the handset 230, the control unit 220 may be comprised e.g. in a portable computing device, such as a smart phone, a smart watch, or the like, that can be kept in a pocket or otherwise carried in a hands-free manner, so as not to hinder the hands-free operation of the described embodiments.

In an embodiment, the control unit 220 may be comprised or integrated in a smart phone (or the like), such that the various functionalities of the control unit 220 described herein are implemented as software executed by the hardware of the smart phone. That is, at least the at least one processor 221 and the at least one memory 222 may be those of the smart phone. In this embodiment, an interface between the control unit 220 and the smart phone may comprise a software interface. Further in this embodiment, the headset 210 and/or the handset 230 are physically separate from the smart phone comprising the control unit 220, and the control unit 220 may communicate with the headset 210 and/or the handset 230 via a suitable wireless interface(s) of the smart phone, such as a suitable radio interface(s) of the smart phone.

In an embodiment, the control unit 220 may be comprised or integrated in a smart watch (or the like), such that the various functionalities of the control unit 220 described herein are implemented as software executed by the hardware of the smart watch. That is, at least the at least one processor 221 and the at least one memory 222 may be those of the smart watch. In this embodiment, an interface between the control unit 220 and the smart watch may comprise a software interface. Further in this embodiment, the headset 210 and/or the handset 230 are physically separate from the smart watch comprising the control unit 220, and the control unit 220 may communicate with the headset 210 and/or the handset 230 via a suitable wireless interface(s) of the smart watch, such as a suitable radio interface(s) of the smart watch.

The control unit 220 as illustrated and hereinafter described is merely illustrative of a control unit that could benefit from embodiments of the invention and, therefore, should not be taken to limit the scope of the invention. It is noted that the control unit 220 may include fewer or more components than those depicted in FIG. 2C.

The at least one memory 222 and the computer program code 223 are configured to, with the at least one processor 221, cause the control unit 220 to at least operate the wearable display 211 via the first interface 240 to display information from the blasting plan logger to a user on the wearable display 211. Herein, the “user” refers to a user of the control unit 220 and thus the user of the wearable system 200, such as a person setting detonators and/or explosives for bore holes at a blasting field. The information from the blasting plan logger may include e.g. information related to the operation of the blasting plan logger, and/or information related to a blasting plan. For example, the information from the blasting plan logger may include information related to a bore hole map associated with the blasting field 150 the user is currently working on. Examples of such information may include locations, depths, diameters, and/or inclinations of bore holes, as well as information about assigned depth of each detonator in a bore hole, and/or information about a assigned order in which detonators are to be placed in a bore hole (when a given bore hole is assigned to receive two or more detonators).

As discussed above, the headset 210 may optionally comprise the microphone 213. The at least one memory 222 and the computer program code 223 may further be configured to, with the at least one processor 221, cause the control unit 220 to operate the microphone 213 via the first interface 240 to receive a voice command from the user of the control unit 220 for operating the control unit 220 and/or for interacting with the blasting plan logger. Furthermore, in this optional embodiment, the at least one memory 222 and the computer program code 223 may further be configured to, with the at least one processor 221, cause the control unit 220 to execute the received voice command. Examples of voice commands for operating the control unit 220 may include e.g. voice commands for activating/deactivating the control unit 220 and/or other devices connected to it (such as activating/deactivating the wearable display 211) and any other operational voice commands. Examples of voice commands for interacting with the blasting plan logger may include e.g. voice commands for operating the blasting plan logger and/or for accessing/entering/updating information related to a blasting plan. For example, the voice commands for interacting with the blasting plan logger may include voice commands for operating accessing/entering/updating detonator delays for a bore hole.

The at least one memory 222 and the computer program code 223 may further be configured to, with the at least one processor 221, cause the control unit 220 to operate the microphone 213 via the first interface 240 to receive a voice sample from the user. Furthermore, in this optional embodiment, the at least one memory 222 and the computer program code 223 may further be configured to, with the at least one processor 221, cause the control unit 220 to perform voice recognition on the received voice sample.

Herein, voice recognition (also called speaker recognition) refers to the identification of a person from characteristics of voices (i.e. voice biometrics). In other words, voice recognition aims to recognize who is speaking. More specifically, herein voice recognition may be used to verify that the speaker is a person authorized to set the detonators and explosives for the bore holes at the blasting field.

As discussed above, the headset 210 may optionally comprise the digital camera 214. The at least one memory 222 and the computer program code 223 may further be configured to, with the at least one processor 221, cause the control unit 220 to operate the digital camera 214 via the first interface 240 to read a visual identifier of an electronic detonator 141, 142. The visual identifier of an electronic detonator may comprise e.g. a barcode, a QR (quick response) code, or numerical code (such as a serial number or the like).

The at least one memory 222 and the computer program code 223 may further be configured to, with the at least one processor 221, cause the control unit 220 to operate the digital camera 214 via the first interface 240 to record a video log about activities of the user. Recording a video log allows maintaining a complete record of everything that happened e.g. when setting the detonators and explosives for the bore holes at the blasting field. This can be useful e.g. for fulfilling legal requirements, for determining what happened if something goes wrong, and for training purposes.

The at least one memory 222 and the computer program code 223 may further be configured to, with the at least one processor 221, cause the control unit 220 to operate the digital camera 214 via the first interface 240 to receive a video feed at least partially covering an eye of the user. Furthermore, in this optional embodiment, the at least one memory 222 and the computer program code 223 may further be configured to, with the at least one processor 221, cause the control unit 220 to perform biometric user identification based on the received video feed. Such biometric user identification based on the received video feed may include e.g. iris recognition and/or retinal scanning. Herein, biometric user identification based on the received video feed may be used to verify that the user is a person authorized to set the detonators and explosives for the bore holes at the blasting field.

As discussed above, the control unit 220 may optionally be connected to the high-accuracy positioning unit 225. The at least one memory 222 and the computer program code 223 may further be configured to, with the at least one processor 221, cause the control unit 220 to determine the location of the user based on signaling received by the high-accuracy positioning unit 225.

As discussed above, the control unit 220 may optionally be connected via the second interface 250 to the handset 230 comprising the wearable near-field communication tag reader 231. The at least one memory 222 and the computer program code 223 may further be configured to, with the at least one processor 221, cause the control unit 220 to operate the wearable near-field communication tag reader 231 via the second interface 250 to read an identifier of an electronic detonator 141, 142 comprised in a near-field communication tag 141_1, 142_1 associated with the electronic detonator 141, 142.

In an example, the user or blasting operator sets the detonators 141, 142 and primary explosives to the bore holes 161-168. The setting is performed with the control unit 220 by opening an accepted blasting plan that has e.g. been downloaded and stored to the control unit 220 from the remote database 130. Here, each detonator 141, 142 may contain an identifying NFC tag 141_1, 142_1 which is read e.g. with the wearable near-field communication tag reader 231. At the same time, the high-accuracy positioning unit 220 will provide coordinates of the location in which the NFC tag was read. All the detonators may be set this way at every bore hole. The control unit 220 may update the blasting plan with information about the read and identified detonators.

Alternative to using the high-accuracy positioning unit 225, the at least one memory 222 and the computer program code 223 may further be configured to, with the at least one processor 221, cause the control unit 220 to determine the location of the user based on one or more received voice commands. In this case, the location may be e.g. relative to a bore hole map. As an example, a voice command may include the phrase “row one, bore hole one” or the like, indicating that the location of the user is at bore hole one of row one of a current bore hole map.

The at least one memory 222 and the computer program code 223 may further be configured to, with the at least one processor 221, cause the control unit 220 to operate the wearable display 211 via the first interface 240 to provide visual feedback to the user. As an example, the visual feedback may include a visual indicator for successfully/unsuccessfully performing a task related to operating the blasting plan logger and/or to accessing/entering/updating information refated to a blasting plan. For example, when the user successfully enters/updates a detonator delay for a bore hole, this may be confirmed with a suitable visual indicator, such as changing the color of a display interface element.

The at least one memory 222 and the computer program code 223 may further be configured to, with the at least one processor 221, cause the control unit 220 to operate the speaker 215 via the first interface 240 to provide audio feedback to the user. As an example, the audio feedback may include an audible indicator for successfully/unsuccessfully performing a task related to operating the blasting plan logger and/or to accessing/entering/updating information related to a blasting plan. For example, when the user successfully enters/updates a detonator delay for a bore hole, this may be confirmed with a suitable audible indicator, such as a beep or the like.

The exemplary embodiments can include, for example, any suitable computer devices, such as smart phones, smart watches, servers, workstations, personal computers, laptop computers, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more satellite communications networks, wireless communications networks, cellular communications networks, 3G communications networks, 4G communications networks, 5G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Passenger Request Broker Architecture (CORBA) passengers, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, and the like. Non-volatile media can include, for example, optical or magnetic disks, magneto-optical disks, and the like. Volatile media can include dynamic memories, and the like. Common forms of computer-readable media can include, for example, a floppy disk, a flexible disk, hard disk, or any other suitable medium from which a computer can read.

It is to be understood that aspects and embodiments of the present disclosure described above may be used in any combination with each other. Several of the aspects and embodiments may be combined together to form a further embodiment of the present disclosure.

While the present inventions have been described in connection with a number of exemplary embodiments, and implementations, the present inventions are not so limited, but rather cover various modifications, and equivalent arrangements, which fall within the purview of prospective claims.

1. A control unit for interfacing with a blasting plan logger and a headset in order to manage a blasting plan, the headset comprising a wearable display and a first short-range wireless transceiver, the control unit connected via a first interface to at least the headset, and the control unit comprising:
a second short-range wireless transceiver;
at least one processor; and
at least one memory comprising computer program code, the at least one memory and the computer program code configured to, with the at least one processor, cause the control unit to at least:
operate the wearable display via the first interface comprising a first short-range wireless connection between the first short-range wireless transceiver and the second short-range wireless transceiver to display information from the blasting plan logger to a user of a wearable system on the wearable display and to update the blasting plan based on information received from the headset.

2. The control unit according to claim 1, wherein the headset further comprises a microphone and the at least one memory and the computer program code are further configured to, with the at least one processor, cause the control unitto:
operate the microphone via the first interface to receive a voice command from the user of the control unit for at least one of operating the control unit or interacting with the blasting plan logger; and
execute the received voice command.

3. The control unit according to claim 2, wherein the at least one memory and the computer program code are further configured to, with the at least one processor, cause the control unit to:
operate the microphone via the first interface to receive a voice sample from the user; and
perform voice recognition on the received voice sample.

4. The control unit according to claim 1, wherein the headset further comprises a digital camera, and the at least one memory and the computer program code are further configured to, with the at least one processor, cause the control unit to:
operate the digital camera via the first interface to read a visual identifier of an electronic detonator.

5. The control unit according to claim 4, wherein the at least one memory and the computer program code are further configured to, with the at least one processor, cause the control unit to:
operate the digital camera via the first interface to record a video log about activities of the user.

6. The control unit according to claim 4, wherein the at least one memory and the computer program code are further configured to, with the at least one processor, cause the control unit to:
operate the digital camera via the first interface to receive a video feed at least partially covering an eye of the user; and
perform biometric user identification based on the received video feed.

7. The control unit according to claim 1, further connected to a high-accuracy positioning unit, wherein the at least one memory and the computer program code are further configured to, with the at least one processor, cause the control unit to:
determine the location of the user based on signaling received by the high-accuracy positioning unit.

8. The control unit according to claim 2, wherein the at least one memory and the computer program code are further configured to, with the at least one processor, cause the control unit to:
determine the location of the user based on one or more received voice commands.

9. The control unit according to claim 1, wherein the at least one memory and the computer program code are further configured to, with the at least one processor, cause the control uni to:
operate the wearable display via the first interface to provide visual feedback to the user.

10. The control unit according to claim 1, wherein the headset ) further comprises a speaker, and the at least one memory and the computer program code are further configured to, with the at least one processor , cause the control unit to:
operate the speaker via the first interface to provide audio feedback to the user.

11. The control unit according to claim 1, further connected via a second interface to a handset comprising a wearable near-field communication tag reader wherein the at least one memory and the computer program code are further configured to, with the at least one processor, cause the control unit to:
operate the wearable near-field communication tag reader via the second interface to read an identifier of an electronic detonator comprised in a near-field communication tag associated with the electronic detonator.

12. The control unit according to claim 1, wherein the control unit further comprises a long-range wireless transceiver for communicating with an external communication network.

13. The control unit according to claim 1, wherein the wearable display is comprised in a safety helmet visor.

14. The control unit according to claim 1, wherein the wearable display is comprised in smart glasses.

15. The control unit according to claim 11, wherein the wearable near-field communication tag reader is comprised in a glove.

16. The control unit according to claim 11, wherein the wearable near-field communication tag reader is wrist attachable.

17. The control unit according to claim 1, wherein the control unit is comprised in a smart phone.

18. The control unit according to claim 1, wherein the control unit is comprised in a smart watch.
